(19) United States
(12) Patent Application Publication
(10) Pub. No.: US 2025/0042037 A1
(43) Pub. Date: Feb. 6, 2025

(54) PROCESS AND SYSTEM FOR CONTROLLING A GRIPPING DEVICE USED IN CYCLES FOR SORTING TIRES ARRANGED IN UNKNOWN ARRANGEMENTS

(71) Applicant: COMPAGNIE GENERALE DES ETABLISSEMENTS MICHELIN, Clermont-Ferrand (FR)

(72) Inventor: MOHAMED-ABBAS KONATE, Clermont-Ferrand (FR)

(21) Appl. No.: 18/717,241

(22) PCT Filed: Dec. 6, 2022
(86) PCT No.: PCT/EP2022/084501

§ 371 Date: Jun. 6, 2024

(30) Foreign Application Priority Data
Dec. 7, 2021 (FR) FR2113035

(51) Int. Cl. B25J 9/16

(52) U.S. Cl. CPC B25J 9/1697; B25J 9/163; B25J 9/1687

(57) ABSTRACT

The invention relates to a computer-implemented control process (201) for controlling the movement of a gripping device that grips a target tire from an unknown arrangement of tires in order to optimize the gripping of a target tire for which a target location must be reached during a sorting cycle. The invention also relates to a tire gripping control system (100) that performs the process of the invention.

### TECHNICAL FIELD

The invention relates to a process and a system for controlling a device for gripping tires in an unknown arrangement. In order to optimize the gripping of a target tire for which a target location must be identified, the invention uses few-shot learning to construct images of overlapping tires without any knowledge of their precise configuration.

### BACKGROUND

In the field of tire sorting, tire arrangements exist that make the tires easier to handle and that allow them to be optimally stored in the available storage space. With reference to FIG. 1, one tire storage embodiment is shown in which several layers of tires 10 partially overlap one another. With this type of tire storage (known in the field as a “rick-rack” arrangement), the tires are stacked in a container 12, with the overlapping direction being reversed from one layer to the next. In this configuration, the space between lateral parts 12a of the container 12 is optimally used. The container 12 can be selected from among containers known for transporting tires, including, but not limited to, pallets, open-bodies of trucks, chain-bound beds of trucks, box-bodies of trucks or vans and equivalents thereof. The structure of this stacking pattern is described in detail in patent DE 2426471 A1.

Other types of tire storage are also known for transporting such tires in containers. In one tire storage embodiment called “storage in rolls”, the tires are stored next to one another on their tread along a common horizontal axis. In one tire storage embodiment called “storage in stacks”, the tires are stacked next to one another on their sidewalls along a common vertical axis.

Automated solutions exist for stacking the tires in containers according to the selected type of storage. These solutions incorporate the visual control of a robot in the context of seizing tires by gripping them. Examples are provided in U.S. Pat. No. 8,244,400 (which discloses a device for the automated stacking of tires on a support that includes a handling device with one or more gripping tool(s) that are coupled for receiving and placing the tires), in U.S. Pat. No. 8,538,579 (which discloses a depalletization system for implementing a process for de-palletizing tires set down on a support, with the system being guided by a robot with a gripping tool), and in U.S. Pat. No. 9,440,349 (which discloses an automatic loader/unloader of tires for stacking them into/unstacking them from a trailer, including an industrial robot capable of a selective articulated movement).

Gripping technologies often require a combination of a laser scan of the surface assumed to contain the objects to be gripped and of knowledge of the intended object (CAD). The system seeks to superpose the elements measured in the actual space with the elements known from the CAD in order to precisely find the object and its spatial configuration so as to then be capable of grasping it in a manner that is consistent with the design of the gripper. Thus, most of the processes that are widely used in the industry work by attempting to control the environment. This can be achieved from a hardware standpoint by demanding installations that are highly specialized for the task, either by learning references in the fixed working environment, or else by attempting to realign a CAD model in a scene of the point cloud type in order to detect an object.

A process requiring a specific hardware installation, however sophisticated it might be, w9333ill no longer work if there are significant variations in the installation. A model realignment requires all objects in the container to be identical (to the nearest scaling factor) and to be mostly visible in order to achieve suitable matching. For example, U.S. Pat. No. 8,538,579 proposes using the CAD data of the tires to perform the “storage densification” work. This requires either a completely uniform pallet of identical tires, the dimension of which is entered once, then the system processes them automatically, or requires reading the tire reference on a case-by-case basis, looking up its dimensions in a CAD database, computing the optimal storage position, and then handling the tire.

Control checks are added to these solutions (for example, labels, barcodes, and their equivalents) that require a certain amount of precision in the stacks, which further slows down the human work and makes the automation of the tasks more complex. In this regard, U.S. Pat. No. 10,124,489 discloses a system for the automated emptying of boxes, including boxes with labels, images, logos and/or their equivalents. The disclosed system learns the appearance of a side removed from a box the first time it removes a box with this appearance. Then, during subsequent extractions, the system attempts to identify other boxes with a matching appearance in a pallet. The system works to “learn” the features (shapes, textures, labels) of an initially grasped box, and these features are then sought in the scene. If this type of box is found in the scene (by performing a simple search by overlaying a model), it is removed directly from a pallet. Otherwise, the system repeats an acquisition as undertaken for the first box. In the case of boxes, there is no interpenetration as in the case of tires. Thus, this type of system is only interested in flat objects.

In the case of tires, there are therefore several types of limits: the scanning time, the requirement for enough of the object to be visible for it to be detected, and knowledge of the CAD data for the object. The complexity is further increased within the context of a loose disparate load. Emptying a loosely loaded container or truck is a task that is unpredictable by definition: the order of the laced tires is not known in advance, and neither is their dimension; accessibility is limited, as is accessibility for gripping; and the tires only can be seen face-on. Therefore, managing the environment is not a viable situation. For tires that partially overlap each other, the approach of U.S. Pat. No. 10,124,489 is not compatible, although the idea of retaining the shape from one model to the next is appropriate.

It is possible to add the possibilities of known deep learning models to visual recognition tasks. Typically, these learning models including supervised learning models require large amounts of labelled data and many iterations in order to train a large number of parameters. This severely limits their applicability to new categories due to the annotation cost.

Learning from a single or from a small number of examples (or “few-shot learning” or “FSL”) can reduce the data collection load for data-intensive applications (in particular, image classification and video event detection), helping to alleviate the load of large-scale supervised data collection (see “One-Shot Learning of Object Categories”, Fei-Fei, Li, Fergus, Rob and Perona Pietro, IEEE Transactions on Pattern Analysis and Machine Intelligence, Vol. 28, Issue 4, pg. 594-611 (April 2006) (https://doi.org/10.1109/TPAMI.2006.79) (“the Fei-Fei reference”). Few-shot learning is a sub-category of machine learning that aims to achieve good learning performance capabilities given limited supervised information in the learning set. In few-shot learning, training is carried out during an auxiliary meta-learning phase, in which transferable knowledge is acquired in the form of good initial conditions, embedding or optimization strategies (see “Learning to Compare: Relation Network for Few-Shot Learning”, Sung, Flood et al., 27 Mar. 2018, arXiv: 1711.06025). Few-shot learning incorporates a means in which a classifier adapts to new categories that have not been seen during training, given only a few examples of each of these categories. Rather than learning from scratch, some knowledge can be drawn from previously learned categories, irrespective of the difference between these categories (see the Fei-Fei reference). Thus, a considerable amount of information can be learned about a category from one, or from a few, images.

Thus, the disclosed invention uses few-shot learning in a system that implements a process for controlling a gripping device used in the cycles for sorting overlapping tires without prior knowledge of their precise configuration.

### SUMMARY OF THE INVENTION

The invention relates to a computer-implemented control process for controlling the movement of a gripping device in order to optimize the gripping of a target tire from an unknown arrangement of tires and for which a target location must be reached during a sorting cycle, characterized in that the control process includes the following steps:
a step of providing a control system including the gripping device;
a step of performing a few-shot learning process that uses an attention mechanism for gripping target tires, with the few-shot learning process including the following steps:
a step of acquiring data corresponding to the arranged tires, during which step a detection system of the control system captures an initial image of the randomly arranged tires;
a step of supplying an extraction neural network and an attention neural network, during which step both neural networks are trained by taking a plurality of sample images obtained during the data acquisition step as training data and a plurality of classifications of objects of images as data labels;
a step of performing a three-dimensional reconstruction process entirely performed on the basis of the data of the extraction neural network and of the attention neural network, during which step coordinates corresponding to the location of an identified target tire and its orientation are reconstructed from this data, so that this reconstruction is used to provide the geometric information required to generate an ideal gripping point on the identified target tire;
a step of approaching the gripping device towards the identified target tire, during which step the attention neural network sends the coordinates corresponding to the location of the identified target tire and its orientation to the gripping device; and
a step of removing the identified target tire from the tire arrangement in order to place it in the target location.

In some embodiments of the control process, the step of supplying the extraction neural network and the attention neural network includes the following steps:
a step of training the extraction neural network to segment a scene viewed by the detection system of the control system; and
a step of constructing the attention mechanism, during which step the attention neural network extracts differentiated features from among various categories in a target tire detection model, such that the model is guided in order to locate key areas in a segmented image.

In some embodiments of the control process, the step of training the extraction neural network includes a step of segmenting data based on a plurality of cycles of a repetitive movement of the gripping device during one or more sorting cycle(s).

In some embodiments of the control process, during the step of performing the 3D reconstruction process, the orientation, the dimensions and the location of the identified target tire are reconstructed from the data of the extraction neural network and the attention neural network.

In some embodiments of the control process, the step of acquiring data of the few-shot learning process includes a step of constructing a point cloud from RGB-D images.

In some embodiments of the control process, during the step of performing a 3D reconstruction process:
the control system constructs a virtual tire in the form of a cylinder on the visible surface of a cluster representing a target tire; and
the center of the identified target tire is identified in order to estimate its internal and external diameter.

In some embodiments of the control process, one or more step(s) of the control process are repeated in a predetermined order in order to arrange the tires in a target arrangement.

In some embodiments of the control process:
the step of approaching the gripping device includes a step of gripping the identified target tire at the ideal gripping point computed during the step of performing the 3D reconstruction process; and
the step of removing the identified target tire includes a step of conveying the identified target tire to the target location, with this step being performed by the gripping device.

The invention also relates to a tire gripping control system that performs the disclosed control process, characterized in that the control system includes:
a gripping device that grips a target tire from an unknown tire arrangement and for which a target location must be reached during a sorting cycle;
a detection system including one or more sensor(s) for gathering information relating to the physical environment around the gripping device;
a memory configured to store an application for analysing data representing a tire arrangement within the field of view of the detection system; and
a processor operationally connected to the memory, the processor including a module for executing the analysis application that applies the data representing the tire arrangement to the extraction neural network and to the attention neural network;
such that the gripping device is set in motion based on the data of the extraction neural network and the attention neural network in order to grip an identified target tire at the ideal gripping point.

In some embodiments of the control system of the invention, the detection system of the control system includes at least one RGB-D type camera attached to the gripping device.

In some embodiments of the control system of the invention, the system further includes a control system for navigating movements of the gripping device between positions for gripping target tires from the tire arrangement.

In some embodiments of the control system of the invention, the gripping device includes a robot with a peripheral gripping component supported by a pivotable elongated arm, with the peripheral gripping component extending from the elongated arm to a free end where a gripper is disposed.

Further aspects of the invention will become apparent from the following detailed description.

### BRIEF DESCRIPTION OF THE DRAWINGS

The nature and various advantages of the invention will become more apparent from reading the following detailed description, and from studying the attached drawings, in which the same reference numerals denote identical elements throughout, and in which:

FIG. 1 shows a perspective view of a tire storage embodiment;

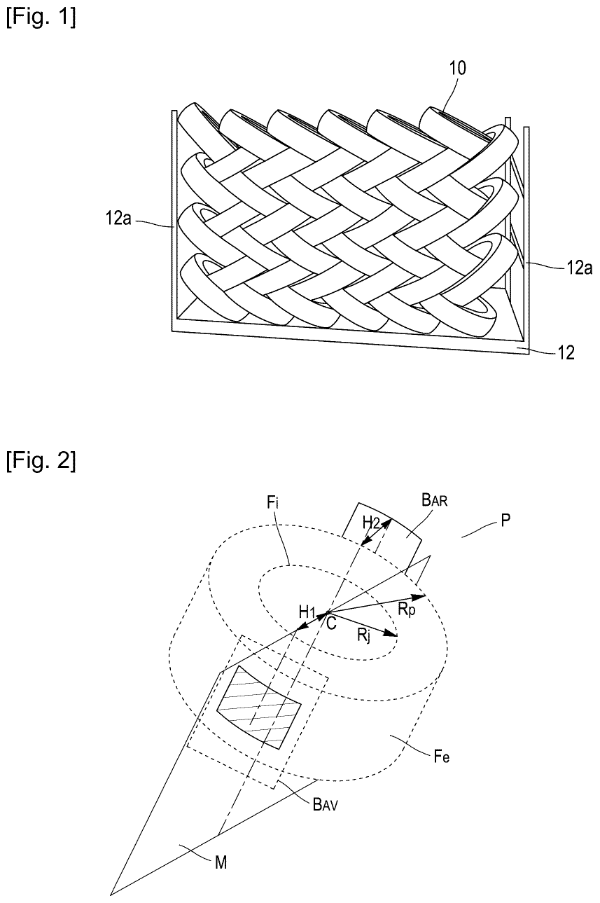

FIGS. 2 and 3 show components of a known tire in a meridian plane;

FIG. 4 shows a partial perspective view of an embodiment of a gripping device used in a control system of the invention;

FIG. 5 shows an example of an image of a tire arrangement in the field of view of the gripping device of the control system;

FIGS. 6 to 10 show views of the scene captured in FIG. 5 during a process of constructing an attention mechanism of a control process of the invention;

FIG. 11 shows an embodiment of the control process of the invention.

### DETAILED DESCRIPTION

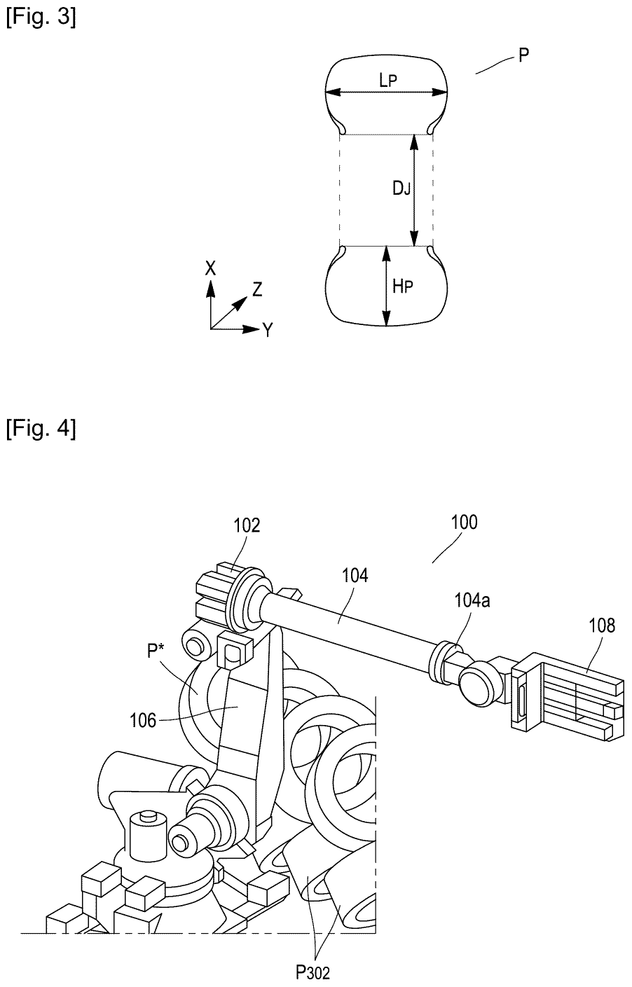

When considering the type of tire storage that best employs the available storage space, the geometry of the tires that are being transported needs to be considered. FIGS. 2 and 3 show schematic diagrams of a tire P, which conventionally includes two circumferential beads intended to allow the tire to be installed with a rim. Each bead includes an annular reinforcing bead wire. The constitution of a tire is typically described by showing its components in a meridian plane, i.e., a plane containing the axis of rotation of the tire. The radial, axial and circumferential directions, respectively, denote the directions perpendicular to the axis of rotation of the tire, parallel to the axis of rotation of the tire, and perpendicular to any meridian plane. The expressions “radially”, “axially” and “circumferentially” mean “in a radial direction”, “in the axial direction” and “in a circumferential direction” of the tire, respectively. The expressions “radially interior” and “respectively radially exterior” mean, respectively, “closer to” and “further away from” the axis of rotation of the tire in a radial direction”.

With reference to FIG. 2, the tire P includes an internal limit F_{I} and an external limit F_{E}, which together define the limits of a sidewall F of the tire P. The internal limit F_{I} separates the sidewall F of the tire and a rim (not shown) on which the tire is intended to be fitted. The tire P also includes a rim radius R_{J} defined as being the distance between a central point C of the tire and the internal limit F_{I} that separates the rim and the sidewall F of the tire. The tire P also includes an internal sidewall diameter defined as being twice the rim radius R_{J}. The tire P also includes a tire radius R_{P} defined as being the distance between the central point C and an external limit F_{E} of the sidewall F that represents the running surface of the tire. The tire P also includes a tire diameter defined as being twice the tire radius R_{P}.

With reference to FIG. 3, the inflated and unloaded tire P has several parameters pertaining to its geometry, including a nominal section width L_{P} and a height H_{P} (with the height H_{P} often being expressed as a percentage of the width L_{P}). The tire P also includes a measurement D_{J} that represents the diameter of a rim on which the tire is intended to be fitted (with this measurement being substantially equal to the internal sidewall diameter F_{I}). It is understood that each of these parameters can be expressed in equivalent known length measurements (for example, in millimetres (mm) or in inches (in)).

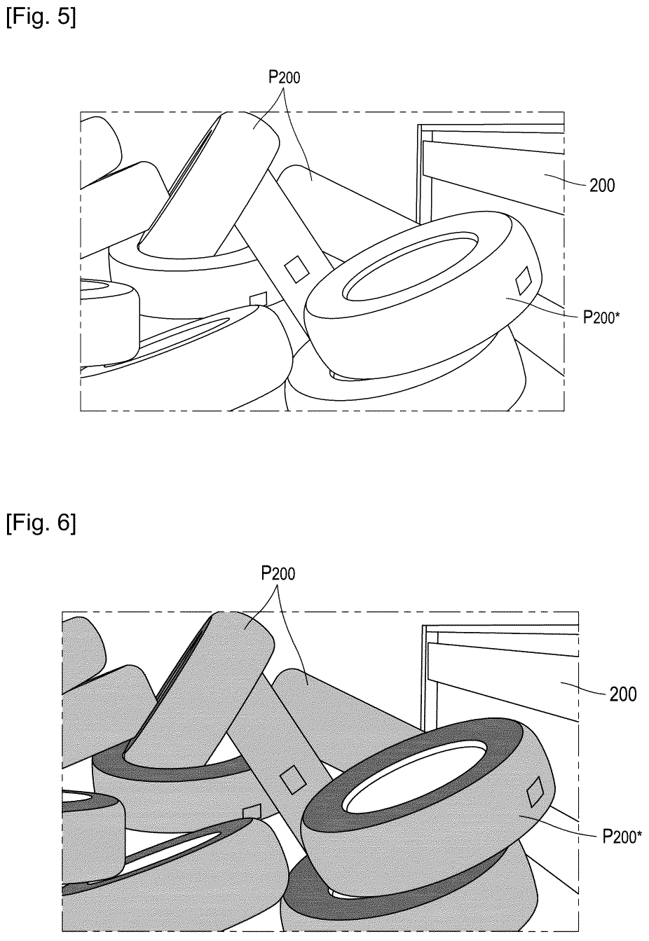

Referring now to FIGS. 4 to 10, in which the same numbers identify identical elements, FIG. 4 shows a gripping device of a tire gripping control system (or “control system”) 100 of the invention. The control system 100 implements the gripping of a target tire from an unknown tire arrangement for which a target location must be reached during a sorting cycle. It is understood that the term “gripping” includes the functions of storing and removing arranged (or “gripped”) tires, as well as the target arrangement of the tires. The term “target tire” (in the singular or the plural) is used herein to refer to a tire that is present in the physical environment of the control system 100 and that is identified for gripping during a sorting cycle. The term “target location” (in the singular or the plural) is used herein to refer to a dedicated space where the target tires gripped by the control system 100 will be arranged in a target arrangement. By way of example, the target locations can include, without limitation, one or more rack(s), one or more skip(s), one or more truck(s), one or more container(s), one or more enclosure(s) and their equivalents. The term “target arrangement” (in the singular or the plural) refers to a desired arrangement for the tires arranged in a target location (for example, in a “rick-rack”, “roll storage”, or “stack storage” manner).

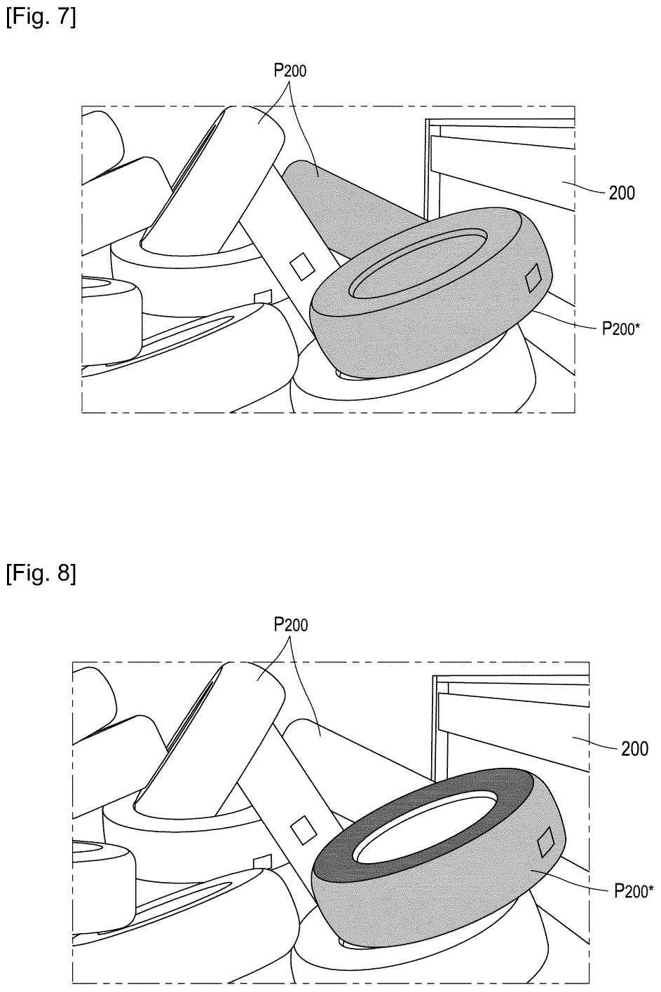

The control system 100 implements a process for controlling the movement of the gripping device (or “control process” or “process”) that incorporates a process for constructing an attention mechanism for gripping target tires. The control system 100 incorporates a combination of vision techniques and few-shot learning to correctly and quickly reconstruct the observed scene from three-dimensional (or “3D”) scattered point clouds, derived from a fragmented front view of the target tires. This combination facilitates a storage optimization function aimed at optimizing the gripping of tires. The control system 100 therefore implements continuous improvement with respect to the selection of the tires to be gripped. The control system 100 can be used in spaces where tires are arranged in an unknown manner and where their target arrangement must be achieved. By way of an example, with reference to FIG. 5, the control system 100 can be used in relation to a container 200 containing gripped tires P₂₀₀. The control system 100 can take the tires P₂₀₀ arranged in the container 200 in order to store them in one or more target location(s) (or, conversely, the control system 100 can take the tires arranged in one or more target location(s) in order to store them in the container 200).

The control system 100 therefore implements a target arrangement of the tires either in the container 200 or in a predetermined target location. It is understood that the control system 100 can operate in a number of physical environments without any previous knowledge of their parameters (for example, an initial or target arrangement of the tires in a truck, in a warehouse, on a pallet or in relation to other known storage and/or transport means). With further reference to FIG. 4, in one embodiment of the control system 100, the gripping device includes a robot 102 of the type disclosed by the Applicant in application FR 2014099. The robot 102 has a peripheral gripping component 108 supported by a pivotable elongated arm 106. The peripheral gripping component 104 extends from the elongated arm 106 to a free end 104a, where a gripper 108 is disposed along a longitudinal axis. The robot 102 is set in motion so that the gripper 108 can effect the gripping of a target tire by the control system 100 during a control process implemented by the control system (as described below). It is understood that the robot 102 is provided by way of an example. For example, the gripping device can include a fixed robot installed in a gripping installation, and attached, for example, to a support from which the robot extends. In this case, it is understood that the robot can be attached to a ceiling, to a wall, to a floor or to any support that allows the control process of the invention to be implemented. It is understood that the gripping device can include at least one roaming robot. By “roaming” it is understood to mean that the gripping device can be set in motion either by integrated movement means (for example, one or more integrated motor(s)) or by non-integrated movement means (for example, one or more mobile mean(s) including autonomous mobile means). It is understood that the gripping device can be a conventional industrial robot or a collaborative robot or even a delta or cable robot. The control system 100 also includes a detection system (not shown) for gathering information relating to the physical environment around the gripping device. The detection system includes one or more sensor(s) (including one or more camera(s)) configured for detecting two-dimensional (2D) and/or three-dimensional (3D) images, for 3D depth detection, and/or other types of detection of the physical environment around the gripping device (it is understood that the terms “sensor” and “camera” are used interchangeably). In the embodiments of the control system 100 incorporating a robot 102 of the type shown in FIG. 4, the one or more sensor(s) of the detection system are attached to at least one from among the elongated arm 104 and the gripper 108 of the robot.

In one embodiment of the control system 100, the detection system includes at least one camera that provides 3D images represented as a set of 3D points with X, Y, Z coordinates, and sometimes red, green, blue colour values (the “RGB” or “RGB-D” format) (called “an RGB-D type camera”). In this embodiment, an RGB-D type camera is attached to at least one from among the elongated arm 104 and the gripper 108 of the robot 102. Two or more RGB-D camera(s) can be oriented so that a predetermined overlap is obtained between the fields of view of the cameras. As used herein, the term “camera” includes one or more camera(s). RGB-D cameras generally provide depth information using depth maps, which are images where each pixel contains the distance between the camera and the corresponding point in space (see FIG. 10). Compared to traditional measurement processes, such as manual measurement and other measurements based on electronic devices, 3D point cloud data originating from RGB-D type cameras have a much higher measurement rate. Using a sparser structure, a point cloud can be constructed from RGB-D images by computing the real world coordinates (for example, the X, Y, Z coordinates) with the intrinsic data of a digital camera. Thus, information relating to the physical environment around the control system 100 is obtained from 3D point cloud data obtained from detection technologies that are capable of accurately and efficiently capturing the 3D surface geometries of the target tires. The term “point cloud” (in the singular or the plural) is used herein to refer to one or more collection(s) of data points in space. One or more camera(s) (or one or more equivalent pieces of equipment) gather three-dimensional (3D) data and detect the surfaces of the objects (for example, of the arranged tires) by virtue of a series of coordinates. Storing the information in the form of a collection of spatial coordinates can allow space to be saved, since many objects do not fill a large part of the environment. Even if the information is not visual, interpreting the data as a point cloud helps to understand the relationship between a plurality of variables by means of classification and segmentation.

The detection system of the control system 100 detects the presence of a tire arrangement in the field of view of the detection system (for example, the field of view of a camera of the control system 100), which triggers it to capture the image of a target tire P_{200*} (see FIG. 5). In all embodiments of the system 100, the system “searches” the image obtained by the detection system for the presence of a tire in the environment around the robot 102. If no tire is detected, the detection system continues to obtain the images until the search of the environment around the robot 102 is exhausted.

The detection system can determine information relating to the physical environment that can be used by a control system (which includes, for example, software for planning the movements of the robot 102). The control system could be located on the robot 102 or it could be remotely communicating with the robot. In embodiments of the control system 100, one or more 2D or 3D sensor(s) mounted on the robot 102 (including, without limitation, navigation sensors) can be integrated in order to form a digital model of the physical environment (including, where applicable, one or more side(s), the floor and the ceiling). Using the obtained data, the control system can cause the robot 102 to move in order to navigate between the target tire gripping positions.

With further reference to FIGS. 5 to 10, the control system 100 therefore implements few-shot learning of tires arranged in a field of view of the camera of the control system 100. The control system 100 includes at least one processor that is operationally connected to a memory, to a detection system (for example, the RGB-D camera of the control system 100), and to a display device (for example, one or more fixed and/or portable screen(s)). The memory is configured to store an application for analysing data representing an arrangement of tires in the field of view of the detection system. The processor includes a module for executing the analysis application that applies the data representing the tire arrangement (shown in images obtained by the detection system) to an extraction neural network and to an attention neural network supplied during a few-shot learning process of a control process implemented by the system 100 (described below). It is understood that the control system 100 can include several computing devices that perform various aspects of the few-shot learning.

The term “processor” (or, alternatively, the term “programmable logic circuit”) refers to one or more device(s) capable of processing and analysing data and including one or more software program(s) for the processing thereof (for example, one or more integrated circuit(s) known to a person skilled in the art as being included in a computer, one or more controller(s), one or more microcontroller(s), one or more microcomputer(s), one or more programmable logic controller(s) (or “PLCs”), one or more application-specific integrated circuit(s), one or more neural network(s), and/or one or more other known equivalent programmable circuit(s)). The processor includes one or more software element(s) for processing data captured by sub-systems associated with the control system 100 (and the corresponding data that is obtained), as well as one or more software element(s) for identifying and locating variances and for identifying their sources in order to correct them.

In the control system 100, the memory can include both volatile and non-volatile memory devices. The non-volatile memory can include solid state memories, such as NAND flash memory, magnetic and optical storage media, or any other suitable data storage device that retains the data when the control system 100 is disabled or loses power. The volatile memory can include a static and dynamic RAM that stores program instructions and data, including a few-shot learning application.

In order to properly control the handling of the gripping device that safely grips the target tire (for example, handling of the robot 102 and positioning of the gripper 108 as shown in FIG. 4), the arrangement of the arranged tires needs to be detected and the ideal target tire for gripping needs to be identified. Thus, the detection data refers to a plurality of records representing the locations of at least one tire or part of a tire tracked over time. For example, the detection data can include one or more position(s) from among the records of the positions of a reference point on part of the tire (for example, the sidewall) over time or at defined time intervals; sensor data taken over time; a video stream that has been processed using a computer vision technique; and/or data indicating the operating status of the gripping device (the robot 102) over time. In some cases, the detection data can include data representing one or more continuous movement(s) of the gripping device before it stops to take one or more of the image(s) of the arranged tires. The detection system of the control system 100 is therefore configured to generate the movement data of the robotic gripping device.

In embodiments of the invention, the detection system of the control system 100 can also include a motion capture device selected from among infrared sensors, ultrasonic sensors, accelerometers, gyroscopes, pressure sensors, and/or other equivalent devices. By way of example, a motion capture device of the control system 100 can include one or a pair of digital gloves for performing remote control movements of the robot 102. In these embodiments, the control system 100 (and particularly the robot 102) learns the movements that attain the target tire arrangement without operator intervention during subsequent gripping processes.

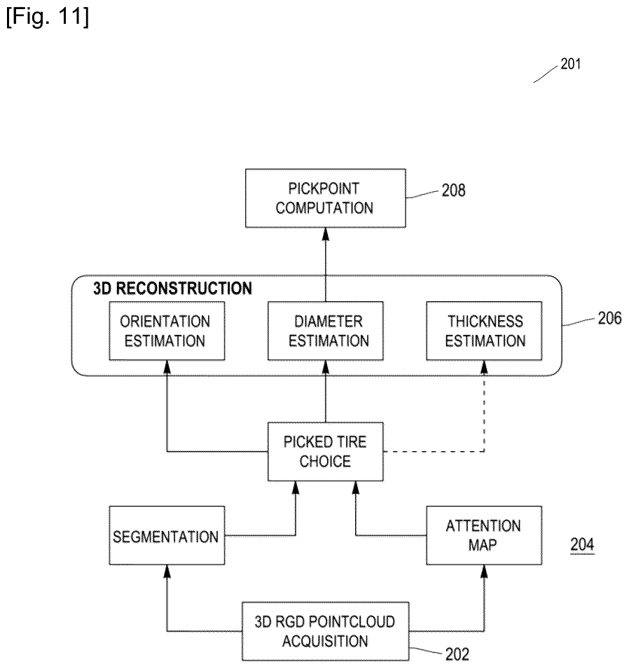

With further reference to FIGS. 5 to 10, and also to FIG. 11, a detailed description is provided, by way of example, of a control process 201 of the invention implemented by the control system 100. It is clearly understood that the process of the invention can be implemented in any physical environment without knowledge of such an environment and without knowledge of the arrangement of the tires.

With reference to FIG. 11, the control process 201 includes a step of implementing a few-shot learning process that uses an attention mechanism for gripping target tires. The few-shot learning process benefits from a neural network structure allowing it to focus only on tires that are likely to be gripped by immediately recognizing them. This makes the control system 100 faster and more reliable since it knows how to adapt to all the tire orientations it sees. Furthermore, the adaptation to the tire arrangements is achieved irrespective of the configuration of the gripping device of the control system.

The few-shot learning process of the process of the invention includes a step 202 of acquiring data corresponding to the arranged tires. With reference to the example in FIG. 5, during this step, the detection system (for example, an RGB-D camera of the control system 100) captures an initial image of the tires P₂₀₀ randomly arranged in an unknown location (for example, the container 200). In this example, a plurality of overlapping tires P₂₀₀ appears in the field of view of the detection system of the control system 100. During this step, a point cloud is constructed from the RGB-D images as described above.

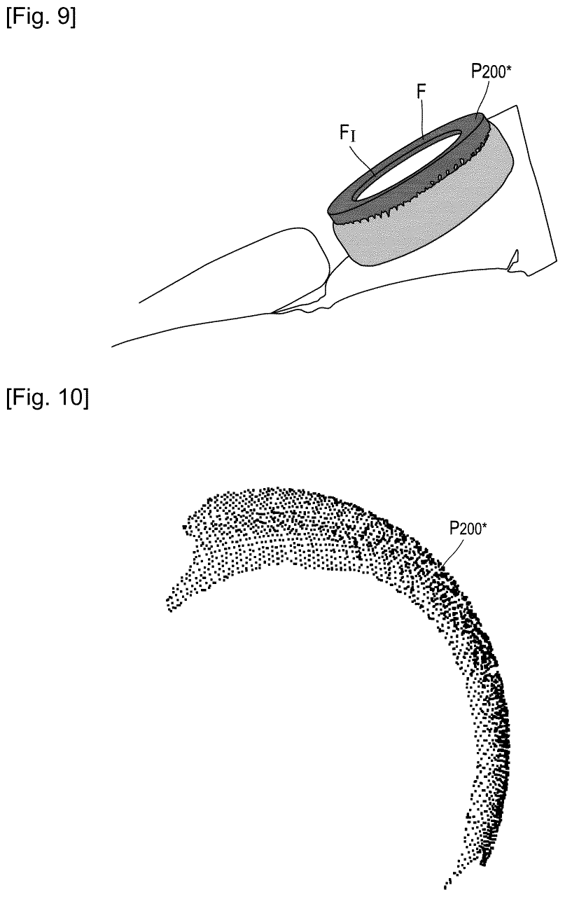

The few-shot learning process also includes a step 204 of supplying an extraction neural network (or “extraction network”) and an attention neural network (or “attention network”). This step includes a step 204a of training the extraction network to segment the scene viewed by the detection system of the control system 100 (for example, see FIG. 6). In one embodiment of the process, this step can include a step of segmenting the data based on a plurality of cycles of a repetitive movement of the gripping device during one or more sorting cycle(s). The segmentation performed during this step differentiates between an object in the image that includes a tire (either a whole tire or a partial tire) and an object in the image that does not include any tire.

During the supply step 204, the extraction network and the attention network are trained by taking a plurality of sample images (obtained during the acquisition step 202) as training data and a plurality of classifications of objects of images (or heat maps) as data labels. By way of example, based on the classification of objects of images, an image can be evaluated in order to determine whether the image is capable of attracting the attention of the detection system of the control system 100 after the image including the target tire to be gripped is fed back to the detection system. During this step, the RGB-D camera provides information relating to the depth of the arranged tires (see FIG. 7).

The supply step 204 includes a step 204b of constructing an attention mechanism. During this step, the attention network extracts differentiated features from various categories in a detection model (or “template”) of the target tire, such that the model is guided to locate key areas with important features in a segmented image (i.e., an image incorporating the tire most likely to be gripped) (see FIG. 8). The model provides the key areas with better monitoring in order to learn any differences from among easily confused categories (for example, the tire most likely to be gripped from among the arranged tires on the basis of a labelled set of images). The accuracy of detecting the target tire in the image is therefore improved so as to be able to select the target tire identified for gripping (see FIG. 9).

The control process 201 further includes a step 206 of implementing a three-dimensional (3D) reconstruction process that is used to provide the geometric information needed to generate the ideal gripping point by the gripping device (for example, gripping by a gripper 108 of a robot 102). The 3D reconstruction process includes a reconstruction process that is wholly carried out on the basis of the data from the extraction and attention networks. During this step, the orientation, the dimensions and the location of the identified target tire are reconstructed from this information data. In so doing, the control system 100 has been able to recognize the arranged tires (including their orientations and positions) from examples of tires during the few-shot learning process.

During this step, the control system 100 constructs a virtual tire in the form of a cylinder on the visible surface of the cluster representing a target tire (see FIG. 10). During this step, the center of the identified target tire is identified in order to estimate its internal and external diameter (with the internal diameter being represented by twice the rim radius R_{J}, as discussed above in relation to FIG. 2) (see FIG. 10). Once the attention network learns the location of the target tire and its orientation, it sends the corresponding coordinates (for example, the X, Y, Z coordinates and the orientation of the tire axis) to the gripping device. At this stage of the process, routing plans and distance conversions are already made in order to extract the identified target tire. Thus, the control system 100 has dictated the expected information fed back from the detection system (namely the RGB-D camera of the control system 100). Consequently, the gripping device applies the movements needed to grip and release the target tire at the ideal gripping point.

The control process 201 further includes a step 208 of approaching the gripping device towards the target tire identified for gripping (see FIGS. 8 and 9 again). This step includes a step of approaching the gripping device towards the identified target tire P_{200*}. This step further includes a step of gripping the identified target tire P_{200*} at the ideal gripping point (as computed during the step 206 of performing the 3D reconstruction process). For the configuration of a robot 102 as shown in FIG. 4, during this step, the gripper 108 is controlled so that it engages a sidewall of the target tire P_{200*} (for example, by extending one or more finger(s) towards a gripping point of the internal limit F_{I} of the sidewall F) (see FIG. 9). It is clearly understood that the implementation of the process of the invention is not limited by the configuration of the gripping device of the control system.

The control process 201 of the invention includes a final step of removing the identified target tire P_{200*} from the tire arrangement so as to place it in a target location. This step includes a step of conveying the identified target tire P_{200*} to the target location that is performed by the gripping device.

The control system 100 can easily repeat the above steps in an order for properly arranging the tires in a target arrangement.

Few-shot learning aims to recognize new visual categories from very few labelled examples. With reference to the robot 102, the initial positioning of the robot 102 (and, in the applicable case, the initial orientation of the gripper 108) is determined from data obtained via the acquisition of images of the control system 100 and of the physical environment in which the control system 100 operates (for example, as shown in FIG. 4). The module for executing the analysis application uses an automatic and adaptive repositioning algorithm to find an ideal starting position of the gripping device for gripping an identified target tire in front of a storage and/or transport medium (for example, a truck, a warehouse, a pallet and the like) where the tires are arranged. The identification of the target tire involves identifying a position where the tire is located that is most likely to be gripped without human intervention. The algorithm allows continuous improvement throughout all the tire gripping operations, ensuring that the control system 100 (and particularly the gripping device) improves from the experience it gains, particularly concerning the selection of tires to be removed. In embodiments of the control process of the invention, the processor can configure the control system 100 (and in particular the gripping device) on one or more parameter(s) of a target tire computed by an image processing module. In these embodiments, it is understood that one or more reinforcement learning means could be used.

The processor can also refer to a reference (for example, a look-up table of various tire sizes) for making a final determination of the target tire parameter(s). The reference can include known tire parameters corresponding to a plurality of known commercially available tires. For example, after an image processing module has computed one or more tire gripping point(s), the processor can compare the computed tire parameters with the known tire parameters stored in the reference. The processor can retrieve the known tire parameters corresponding to commercially available tires that most closely match the computed tire parameters in order to configure the gripping device. The tire reference can include measurements corresponding to a plurality of commercially available tires. By way of example, for a tire size of 225/50 R17, the number “225” identifies the cross-sectional area of the tire in millimetres, the number “50” indicates the aspect ratio of the sidewall, and the measurement “R17” represents the rim diameter in inches (which is approximately 43.18 centimetres).

The control system 100 of the invention can include pre-programming of control information. For example, an adjustment of the process can be associated with the parameters of typical physical environments in which the control system 100 operates.

In embodiments of the invention, the control system 100 (and/or an installation incorporating the control system 100) can receive audio commands (including voice commands) or other audio data representing, for example, the start or the termination of the acquisition step 202, the start or the termination of the movement of the gripping device or a manipulation of its gripper (for example, the gripper 108). The request can include a request for the current status of an ongoing control process. A generated response can be represented audibly, visually, in a tactile manner (for example, by way of a haptic interface) and/or in a virtual and/or augmented manner. This response, together with the corresponding data, can be recorded in a neural network.

For all embodiments of the control system 100, a monitoring system could be implemented. At least part of the monitoring system can be supplied in a portable device such as a mobile network device (for example, a mobile telephone, a laptop computer, one or more portable devices connected to the network (including “augmented reality” and/or “virtual reality” devices, wearable clothing connected to the network and/or any combinations and/or any equivalents)). It is conceivable for the detection and comparison steps to be able to be performed iteratively.

The terms “at least one” and “one or more” are used interchangeably. The ranges provided as lying “between a and b” encompass the values “a” and “b”.

Although particular embodiments of the disclosed device have been illustrated and described, it will be understood that various changes, additions and modifications can be made without departing from either the spirit or the scope of the present description. Therefore, no limitation should be imposed on the scope of the invention described, apart from those disclosed in the appended claims.

1.-12. (canceled)

13. A computer-implemented control process for controlling a movement of a gripping device in order to optimize gripping of a target tire from an unknown arrangement of tires and for which a target location must be reached during a sorting cycle, the computer-implemented control process comprising the following steps:
a step of providing a control system including the gripping device;
a step of performing a few-shot learning process that uses an attention mechanism for gripping target tires, the few-shot learning process comprising the following steps:
a step of acquiring data corresponding to the arrangement of tires, during which step a detection system of the control system captures an initial image of randomly arranged tires; and
a step of supplying an extraction neural network and an attention neural network, during which step both neural networks are trained by taking a plurality of sample images obtained during the data acquisition step as training data and a plurality of classifications of objects of images as data labels;
a step of performing a three-dimensional reconstruction process wholly carried out on a basis of the data of the extraction neural network and of the attention neural network, during which step coordinates corresponding to a location of an identified target tire and an orientation of the identified target tire are reconstructed from the data, the three-dimensional reconstruction obtained being used to provide geometric information required to generate an ideal gripping point on the identified target tire;
a step of approaching the gripping device towards the identified target tire, during which step the attention neural network sends the coordinates corresponding to the location of the identified target tire and the orientation of the identified target tire to the gripping device; and
a step of removing the identified target tire from the arrangement of tires in order to place the identified target tire in the target location.

14. The computer-implemented control process according to claim 13, wherein the step of supplying the extraction neural network and the attention neural network comprises the following steps:
a step of training the extraction neural network to segment a scene viewed by the detection system of the control system; and
a step of constructing an attention mechanism, during which step the attention neural network extracts differentiated features from among various categories in a target tire detection model, such that the target tire detection model is guided in order to locate key areas in a segmented image.

15. The computer-implemented control process according to claim 14, wherein the step of training the extraction neural network comprises a step of segmenting data based on a plurality of cycles of a repetitive movement of the gripping device during one or more sorting cycles.

16. The computer-implemented control process according to claim 15, wherein, during the step of performing the three-dimensional reconstruction process, the orientation, dimensions and the location of the identified target tire are reconstructed from the data of the extraction neural network and of the attention neural network.

17. The computer-implemented control process according to claim 13, wherein the step of acquiring data of the few-shot learning process comprises a step of constructing a point cloud using at least one RGB-D type camera of the detection system of the computer-implemented control system for capturing RGB-D images.

18. The computer-implemented control process according to claim 13, wherein, during the step of performing a three-dimensional reconstruction process:
the control system constructs a virtual tire in a form of a cylinder on a visible surface of a cluster representing a target tire; and
a center of the identified target tire is identified in order to estimate an internal and external diameter of the identified target tire.

19. The computer-implemented control process according to claim 13, wherein one or more steps of the computer-implemented control process are repeated in a predetermined order in order to arrange the tires in a target arrangement.

20. The computer-implemented control process according to claim 13, wherein the step of approaching the gripping device comprises a step of gripping the identified target tire at the ideal gripping point computed during the step of performing the three-dimensional reconstruction process, and
wherein the step of removing the identified target tire comprises a step of conveying the identified target tire to the target location, the step of removing being performed by the gripping device.

21. A tire gripping control system that performs the computer-implemented control process according to claim 13, the tire gripping control system comprising:
a gripping device that grips a target tire of an unknown tire arrangement and for which a target location must be reached during a sorting cycle;
a detection system comprising one or more sensors for gathering information relating to a physical environment around the gripping device;
a memory configured to store an application for analyzing data representing a tire arrangement within a field of view of the detection system; and
a processor operationally connected to the memory, the processor comprising a module for executing the analysis application that applies the data representing the tire arrangement to the extraction neural network and to the attention neural network,
wherein the gripping device is set in motion based on the data from the extraction neural network and the attention neural network in order to grip the identified target tire.

22. The control system according to claim 21, wherein the detection system of the control system comprises at least one RGB-D type camera attached to the gripping device.

23. The control system according to claim 21, further comprising a control system for controlling movements of the gripping device between positions for gripping target tires from the unknown tire arrangement.

24. The control system according to claim 21, wherein the gripping device comprises a robot with a peripheral gripping component supported by a pivotable elongated arm, with the peripheral gripping component extending from the elongated arm to a free end where a gripper is disposed.
